(19) United States
(12) Patent Application Publication
(10) Pub. No.: US 2026/0225559 A1
(43) Pub. Date: Aug. 6, 2026

(54) SECURE REMOTE DELEGATION METHOD FOR A BIOMETRIC RECOGNITION SYSTEM

(71) Applicant: AUMOVIO Germany GmbH, Frankfurt am Main (DE)

(72) Inventors: Steve LECOCQ, Le Chesnay-Rocquencourt (FR); Jean-Philippe GOURDON, RAMBOUILLET (FR)

(73) Assignee: AUMOVIO Germany GmbH, Frankfurt am Main (DE)

(21) Appl. No.: 19/464,875

(22) Filed: Jan. 30, 2026

(30) Foreign Application Priority Data
Feb. 3, 2025 (FR) FR2501050

(51) Int. Cl. B60R 25/25; B60R 25/01; B60R 25/24; B60R 25/30; G07C 9/00; G07C 9/22; G07C 9/27

(52) U.S. Cl. CPC B60R 25/25; B60R 25/01; B60R 25/24; B60R 25/305; G07C 9/00563; G07C 9/00571; G07C 9/22; G07C 9/27; B60R 2325/205; G07C 2209/12

(57) ABSTRACT

A remote delegation method for a biometric recognition system including the following steps: constructing a profile comprising a biometric capture and a smartphone number; transmitting the profile to the server; creating an encryption key; transmitting the profile and the encryption key to the object to be protected; extracting a biometric template and creating a unique identifier; transmitting the identifier to the server; encrypting the identifier using the encryption key and creating a graphic code containing the encrypted identifier; transmitting the graphic code to the smartphone; and the server destroying the encryption key.

### CROSS-REFERENCE TO RELATED APPLICATIONS

This application claims priority under 35 U.S.C. § 120 to French Patent Application No. 2501050 filed on Feb. 3, 2025, the entire disclosure of which is incorporated by reference herein.

### FIELD OF THE INVENTION

The invention relates to a remote delegation method for a biometric recognition system.

### BACKGROUND OF THE INVENTION

The use of a biometric recognition system is known for controlling access to an object to be protected, such as a secure location or a motor vehicle. Such a system is advantageous in that it secures access by only authorizing access to a duly authorized person. An advantage of such a biometric recognition system is that it expressly recognizes the authorized person themselves and not a medium belonging to them, such as a key, a fob or a smartphone, which may have been stolen from its rightful owner. In this case, the key is the authorized person themselves.

In a biometric recognition system, when an applicant requests access to an object to be protected, the system conventionally captures biometric data directly from the applicant. This biometric capture is analyzed as a biometric template in the form of vectors that can be compared from one biometric capture to another. The biometric template is compared with the biometric templates stored in a database of authorized persons. If the biometric template is present in the database, the applicant is considered to be authorized and they are granted access to the object to be protected.

In an access control system using a medium such as a key, a fob or a smartphone, a compliant medium must be reproduced for each authorized user.

In a biometric recognition system, an authorization must be able to be created for a new user, this also being known as enrolment. In addition, a person with access rights, called delegator, such as the owner of the object to be protected, must be able to delegate all or some of their access rights to a delegatee. Advantageously, such delegation must be able to be completed remote from the object to be protected. Therefore, a remote delegation method is sought. However, this remote delegation must be completely secure.

### SUMMARY OF THE INVENTION

An aspect of the invention proposes providing a secure remote delegation method for a biometric recognition system.

To this end, an aim of the invention is a remote delegation method for a biometric recognition system comprising a computer device of the delegator, a server and an object to be protected, comprising the following steps of:
the computer device of the delegator constructing a profile of the delegatee, said profile comprising a first biometric capture of the delegatee and a smartphone number of the delegatee;
the computer device of the delegator configuring usage parameters of the delegatee and adding them to the profile of the delegatee;
the computer device of the delegator transmitting the profile of the delegatee to the server;
the server creating an encryption key;
the server transmitting the profile of the delegatee and the encryption key to the object to be protected;
the object to be protected extracting a first biometric template from the first biometric capture of the delegatee and the object to be protected creating a first unique identifier for the delegatee, assigned a “pending validation” status;
the object to be protected transmitting the first identifier to the server and deleting the first biometric capture;
the object to be protected authorizing the reading of a graphic code by its sensor;
the server encrypting the first identifier using the encryption key and the server creating a graphic code containing the encrypted first identifier;
the server transmitting the graphic code to the smartphone of the delegatee, using its number;
the server destroying the encryption key.

Specific features or embodiments, which can be used alone or in combination, are:
the profile also includes a name of the delegatee;
   the transmission step and the encryption step are replaced by the following steps of:
      the object to be protected encrypting the first identifier using the encryption key, the object to be protected transmitting the encrypted first identifier to the server and deleting the first biometric capture;
   the server creating a graphic code containing the encrypted first identifier;
   the method further comprises the following steps of:
      presenting the delegatee in front of the object to be protected and displaying the graphic code on their smartphone;
   the object to be protected reading the graphic code, the object to be protected extracting the encrypted first identifier, the object to be protected decrypting the encrypted first identifier using the encryption key in order to retrieve the first identifier;
   the object to be protected using its sensor to take a second biometric capture of the delegatee;
   the object to be protected extracting a second biometric template from the second biometric capture of the delegatee and the object to be protected comparing the second biometric template with the biometric templates in a database in order to determine a possible second identifier;
   the object to be protected checking that the first identifier is identical to the second identifier;
   the object to be protected storing the second identifier, assigned a “validated” status, in the database;
   the object to be protected destroying the encryption key and the object to be protected deactivating the reading of a graphic code by its sensor;
   the biometric check is performed on the face, an eye, a fingerprint, a palm or a voice and a biometric capture is respectively an image of the face, an image of the eye, an image of the fingerprint, an image of the palm or a sound recording of the voice, and the sensor performing a biometric capture is, as applicable, a photographic appliance, a camera or a microphone;
   the graphic code is a barcode, a QR code, or any other equivalent graphic means, and the sensor is a dedicated reader or a camera;
   the object to be protected is a motor vehicle;
   the usage parameters include:
      access authorization: unlocking an opening, all the openings, the trunk;
   engine start authorization: yes/no, number of times;
   delegation authorization: yes/no;
   delegation time: start date, duration or end date, or permanent delegation.

An aspect of the invention also relates to a biometric recognition system for controlling access to an object to be protected, implementing the remote delegation method as described above.

### BRIEF DESCRIPTION OF THE DRAWINGS

An aspect of the invention will be better understood upon reading the following description, which is provided solely by way of an example, and with reference to the appended figures, in which:

FIG. 1 shows a synoptic view of a biometric recognition system and illustrates the steps of preparing the delegation;

FIG. 2 shows a synoptic view of the biometric recognition system and more specifically illustrates the steps of validating a prospective delegatee.

### DETAILED DESCRIPTION OF EXEMPLARY EMBODIMENTS

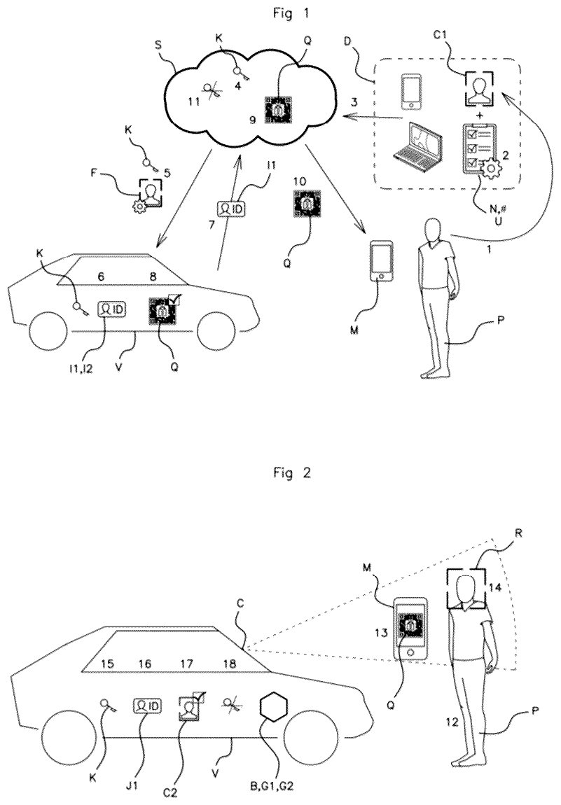

With reference to FIG. 1, an aspect of the invention relates to a biometric recognition system. This system comprises an object V to be protected, a server S and a computer device D of the delegator T.

The delegator T is a person with access rights to the object V to be protected and the authorization to delegate these rights to a delegatee P. The delegatee P is a person wishing to be delegated all or some of the access rights to the object V to be protected.

The object V to be protected and the server S or the computer device D equally include computer processing means in order to be able to carry out the processing operations that will be described in further detail hereafter, and communication means for communicating with each other so as to exchange data, as will be described in further detail hereafter.

The computer device D of the delegator T can be a smartphone or a computer or any other equivalent means.

The delegatee P must be in possession of a smartphone M, but only when receiving the delegation. Then, once the delegation has been completed, the delegatee P only needs to present themselves with the recognized biometric element R, such as their face for a facial recognition system. One of the advantages of a biometric recognition system is that a user does not need to present any media, such as a key or a fob, as the media is replaced by the biometric element R.

An aspect of the invention relates to a delegation method for a biometric recognition system protecting an object V to be protected. This method advantageously can be carried out remotely, at least during the delegation preparation phase, without requiring the presence of the object V to be protected.

In this document, the steps of the method are numbered twice, with a first absolute ordinal number xx and with a second code comprising a letter indicating the component that performs the step, followed by a second ordinal number yy relating to the component, including Dyy, which represents the computer device D of the delegator T, Syy, which represents the server S, and Vyy, which represents the object V to be protected.

This method comprises the following steps. During a first step, 01-D01, the computer device D of the delegator T constructs a profile F of the delegatee P. This profile F includes a first biometric capture C1 of the delegatee P. This first biometric capture C1 is a representation of the biometric element R that can be used by the biometric recognition system to extract a first biometric template G1 and its vectors and store them in a database B.

The biometric element R is a physical characteristic specific to each individual, allowing them to be recognized following a learning process. This biometric element R can be, for example, the face, an eye, a fingerprint (or dactylogram), a palm or a voice. Depending on the nature of the biometric element R, a biometric capture C1 is taken in the form of a graphic recording or a sound recording. Thus, the biometric capture C1 is an image for the face, the eye, the fingerprint or the palm, and a sound recording for the voice.

Therefore, irrespective of which component performs the biometric capture C1, C2, from among the object V to be protected, the device D or even the smartphone M, or any other device, this component includes a photographic appliance, a camera for capturing an image or a microphone for voice capture.

Based on the biometric capture C1, which is a recording of the biometric element R, the biometric recognition system performs an extraction. This extraction allows, like a projection, a biometric template G1 to be produced from the biometric capture C1 that is characteristic of the biometric element R, despite any variations from one biometric capture to another. Thus, even if the biometric captures C1 of the same biometric element R vary from one to another, the extracted biometric template G1 is substantially identical and thus allows two biometric captures to be compared, provided they originate from the same person.

Throughout the remainder of the description, for the sake of simplicity, yet without limiting the scope of the invention, it is assumed that the biometric element R is the face, with the system performing facial recognition. In this case, the biometric capture C1 is a photo of the face of the delegatee P. In order to be entered into the profile F, a photo/biometric capture C1 of the delegatee P is required that is of sufficient quality to allow the biometric recognition system to extract a biometric template G1. This photo can be obtained by any means. It can be captured using a photographic appliance or a camera. This photograph can be taken by a photographic appliance built into the computer device D. It can be taken by a digital photographic appliance, such as that of the smartphone M of the delegatee P, and then can be transmitted to the device D. It can be available in a storage medium of the delegatee P and transmitted to the device by any means, such as an MMS or even an email.

It should be noted in this case that while biometric capture C1 can be performed at separate points, M and D, the extraction of a biometric template G1 from a biometric capture C1 is, according to an aspect of the invention, performed at a single processing point, in this case located in (the computer of) the object V to be protected. According to an aspect of the invention, several such extractions of biometric templates are performed, including two during the delegation method, then at least once for each access attempt by the delegatee P. This single processing point is advantageous in that it unifies and localizes a technology that is security sensitive. This also allows regulatory obligations to be met.

Still during the first step, the method completes the profile by adding thereto data specific to the delegatee P.

This data includes a smartphone M number # of the delegatee P. This number # is used in the delegation method to send the smartphone M data that is useful to the delegatee P for the delegation method. This number # is typically entered by the delegator T using an interface on their device D or by copying this number from their phone book, which is stored on their device D.

During another step 02-D02, the computer device D of the delegator T configures usage parameters U of the delegatee P and adds them to the profile F of the delegatee P. The usage parameters U define the characteristics of the delegation in terms of rights and duration. They are defined in further detail hereafter.

During another step 03-D03, the computer device D of the delegator T transmits the profile F of the delegatee P to the server S.

Any communication between the device D and the server S is typically carried out over the internet.

Upon receipt, the server S, during another step 04-S01, creates an encryption key K. In order to secure the method, this encryption key K is single-use. Furthermore, as will become apparent hereafter, in steps 11-S05 and 18-V09, this encryption key K is destroyed after its first and only use. This single-use feature of the encryption key K renders any attempted fraud by brute force ineffective.

During another step 05-S02, the server S transmits the profile F of the delegatee P and the encryption key K to the object V to be protected.

Any communication between the server S and the object V to be protected is typically carried out over the internet.

During another step 06-V01, the object V to be protected extracts a first biometric template G1 from the first biometric capture C1 of the delegatee P, originating from the profile F.

During the same step 06-V01, the object V to be protected creates a first unique identifier I1 associated with the delegatee P. Upon creation, this identifier I1 is assigned a provisional status: “pending validation”.

During another step 07-V02, the object V to be protected transmits the first identifier I1, created in the previous step 06-V01, to the server S.

During the same step 07-V02, the object V to be protected deletes the first biometric capture C1, which is no longer useful.

During another step 08-V03, the object V to be protected authorizes the reading of a graphic code Q by its sensor C. This authorization will only be valid for a limited time, in order to secure a presentation operation, carried out in step 12-P01 and described in further detail hereafter.

During another step 09-S03, the server S encrypts the first identifier I1 using the encryption key K so as to obtain an encrypted first identifier J1.

During the same step 09-S03, the server S creates a graphic code Q containing the encrypted first identifier J1.

During another step 10-S04, the server S transmits the previously created graphic code Q to the smartphone M of the delegatee P, using its number #.

Any communication between the server S and the smartphone M of the delegatee P is typically carried out over the GSM network, for example, by means of an SMS/MMS. To this end, the server S uses the number # that identifies the smartphone M on said GSM network.

During another step 11-S05, the server S destroys the encryption key K, which, since it has been used, is no longer useful to the server S.

The data specific to the delegatee P can also optionally include a name N of the delegatee P. This name N is used to designate the delegatee P and, optionally, to address them in such a way that they can recognize themselves. This name N is typically entered by the delegator T using an interface on their device D. Alternatively, it can be entered by the delegatee P themselves on their smartphone M and then transmitted to the device D.

In the first instance, the identifier I1 is transmitted (step 07-V02) to the object V to be protected, which encrypts it using the encryption key K (step 09-S03). This embodiment is preferred because it separates the security operations between the participants, in this case the object V to be protected and the server S, so as to strengthen the overall security of the system, notably in the event of the corruption of one of the participants.

However, the encryption key K is present on the server S before transmission. Furthermore, alternatively, it is possible to perform the encryption on the object V to be protected and to then transmit the encrypted identifier J1.

Therefore, steps 07-V02 and 09-S03 respectively become:—07-V02: the object V to be protected encrypting the first identifier I1 using the encryption key K, the object V to be protected transmitting the encrypted first identifier J1 to the server S and deleting the first biometric capture C1;
09-S03: the server S creating a graphic code Q containing the encrypted first identifier J1. The other steps remain unchanged.

The first part of the method has been described above. This first part could be described as the preparatory part. In this part, the delegator T sets up/authorizes the delegation. With all the elements now in place, the second part of the method can now take place. This second part could be described as the final part. In this second part, the delegatee P accepts the delegation and collects it.

In this second part, which is more specifically illustrated in FIG. 2, the method further comprises the following steps.

During another step 12-P01, the delegatee P, or more precisely the prospective delegatee P, presents themselves before the object V to be protected.

During this same step, the delegatee P displays the graphic code Q received from the server S on the screen of their smartphone M, so as to make it visible, and presents it in a capture zone of the sensor C of the object V to be protected.

During another step 13-V04, the object V to be protected reads the graphic code Q using its sensor C, which is authorized to perform this reading.

During the same step 13-V04, the object V to be protected extracts the encrypted first identifier J1 by analyzing the graphic code Q. During the same step 13-V04, the object V to be protected decrypts the encrypted first identifier J1. This decryption is performed using the encryption key K and allows the first identifier I1 to be retrieved.

During another step 14-V05, the object V to be protected performs a second biometric capture C2 of the prospective delegatee P via its sensor C. Thus, in the case of facial recognition, the sensor C is an image sensor, such as a camera, and the sensor C performs a biometric capture C2 of the face of the prospective delegatee P.

It should be noted that the sensor C can include several components. Thus, the sensor C comprises a means for reading the graphic code Q. This means is typically an optical means, such as a camera, but also can be a dedicated sensor comprising special lighting, such as a laser, and/or a display window. The sensor C further comprises a means for capturing the biometric capture C1. This means can be optical for a visual biometric element R or even can be a microphone for an audio biometric element R.

During another step 15-V06, the object V to be protected proceeds to the extraction of a second biometric template G2 from the second biometric capture G2 of the previously captured prospective delegatee P.

During the same step 15-V06, the object V to be protected compares the previously extracted second biometric template G2 with the biometric templates present in a database B, in order to determine a possible match/identity. In the event of a match, it determines a second identifier I2, which in the database B is associated with the biometric template corresponding to the second biometric template G2.

During another step 16-V07, the object V to be protected checks that the first identifier I1, which originates from the graphic code Q transmitted by the delegatee P, associated with the first biometric template G1 extracted from the first biometric capture C1, is indeed identical to the second identifier I2, which originates from the database B by biometric recognition of the second capture C2 performed directly on the prospective delegatee P.

During another step 17-V08, the object V to be protected validates the second identifier I2 and assigns a “validated” status thereto, then stores it in the database B.

During another step 18-V09, the object V to be protected destroys the encryption key K, which is no longer useful, so that this encryption key K cannot be reused. During the same step 18-V09, the object V to be protected deactivates the authorization for its sensor C to read a graphic code, again for security purposes.

The graphic code Q can be any visible code capable of storing information. According to another feature, the graphic code Q can be a barcode, a QR code, or any other equivalent graphic means. Since the graphic code Q is visual, the sensor C is an optical sensor, such as a camera or a dedicated reader.

The object V to be protected can be any fixed or mobile location, the access or use of which is to be protected. According to another feature, the object V to be protected is a motor vehicle V.

The usage parameters U include access authorizations, usage authorizations, sub-delegation authorizations, as well as elements defining the duration of the delegation.

The access authorizations may or may not include an authorization to unlock an opening. It is thus possible to distinguish between several access levels depending on the access possibilities. In the case of a motor vehicle, it is possible to distinguish between an authorization to open a door, the door of the driver, all the doors or even the trunk.

The usage authorizations may or may not include an authorization to use or start up functional equipment. Such an authorization relates to functional equipment. It specifies how functional equipment can be used and, for example, the number of uses. In the case of a motor vehicle, it is possible to distinguish between an authorization to start the engine and/or move the vehicle. If the vehicle is on loan, the delegatee P may be authorized to drive the vehicle. In the event that the vehicle is used as a delivery container, the delivery person may be authorized to open the trunk, but the delivery person typically is not authorized to start the engine.

Authorizations to sub-delegate define whether or not a delegatee can in turn delegate, as well as the limits of the rights that they may or may not sub-delegate.

The elements defining the duration of the delegation typically include a start date and a duration or end date. A delegation also can be permanent, indicated by the absence of a duration or end date. Alternatively, a time limit may be indicated in terms of the number of uses.

In all cases, including the case of a permanent delegation, a delegator T can revoke a delegation at any time. Similarly, in the event of the transfer of the object V to be protected, all delegations are immediately revoked.

As described, the method proposes significant security for remote delegation. This is mainly achieved through the use of the following features:
multi-factor authorization;
encryption using a single-use encryption key K;
single validation: the delegatee P is only given one attempt to read the graphic code Q in order to be recognized by the object V to be protected;
communications use different, asynchronous transmission channels, preventing effective fraudulent interception of the exchanged data or rendering it partial and therefore ineffective.

A delegator T must create an account and be registered on the server S in order to be able to delegate. The same applies to a delegatee P wishing to delegate. This provides security for the delegator T.

Other advantages of the method are as follows.

A delegator T must have a dedicated application in order to be able to carry out a delegation. In contrast, a delegatee P does not need to install a dedicated application in order to be a delegatee P. Once the remote delegation has been carried out via their smartphone M, the latter becomes unnecessary. In contrast, like any user of a biometric recognition system, they only need their body, in that they carry the biometric element R, which is used as an access key by the biometric recognition system.

Another advantage of the method as implemented is that the personal data of the delegatee P only circulates in the server/cloud in encrypted form. Furthermore, this data is only stored in the object V to be protected or in the device D. This ensures compliance with the European General Data Protection Regulation, GDPR.

Another security advantage, linked to the fact that the extraction of biometric templates G1 and G2 is only carried out in the object V to be protected, is that these biometric templates G1 and G2 are only produced and stored in the object V to be protected, thus limiting any risks of leaks.

Another advantage, linked to the specific features for implementing the delegation method, and notably the lack of transmission of biometric templates G1 and G2, is that the delegation is completely independent of the biometric solution that is used.

Aspects of the invention have been illustrated and described in detail in the drawings and the above description. This should be considered to be illustrative and provided by way of an example and not as limiting the invention to this description only. Many alternative embodiments are possible.

1. A remote delegation method for a biometric recognition system comprising a computer device of the delegator, a server and an object to be protected, the method comprising:
01-D01: the computer device of the delegator constructing a profile of the delegatee, said profile comprising a first biometric capture of the delegatee and a smartphone number of the delegatee;
02-D02: the computer device of the delegator configuring usage parameters of the delegatee and adding them to the profile of the delegatee;
03-D03: the computer device of the delegator transmitting the profile of the delegatee to the server;
04-S01: the server creating an encryption key;
05-S02: the server transmitting the profile of the delegatee and the encryption key to the object to be protected;
06-V01: the object to be protected extracting a first biometric template from the first biometric capture of the delegatee and the object to be protected creating a first unique identifier for the delegatee assigned a “pending validation” status;
07-V02: the object to be protected transmitting the first identifier to the server and deleting the first biometric capture;
08-V03: the object to be protected authorizing the reading of a graphic code by its sensor;
09-S03: the server encrypting the first identifier using the encryption key and the server creating a graphic code containing the encrypted first identifier;
10-S04: the server transmitting the graphic code to the smartphone of the delegatee, using its number; and
11-S05: the server destroying the encryption key.

2. The method as claimed in claim 1, wherein the profile further comprises a name of the delegatee.

3. The method as claimed in claim 1, wherein the transmission step 07-V02 and the encryption step
09-S03 are replaced by the following steps of:
07-V02: the object to be protected encrypting the first identifier using the encryption key, the object to be protected transmitting the encrypted first identifier to the server and deleting the first biometric capture;
09-S03: the server creating a graphic code containing the encrypted first identifier.

4. The method as claimed in claim 1, further comprising:
12-P01: presenting the delegatee in front of the object to be protected and displaying the graphic code on their smartphone;
13-V04: the object to be protected reading the graphic code, the object to be protected extracting the encrypted first identifier, the object to be protected decrypting the encrypted first identifier using the encryption key in order to retrieve the first identifier;
14-V05: the object to be protected using its sensor to take a second biometric capture of the delegatee;
15-V06: the object to be protected extracting a second biometric template from the second biometric capture of the delegatee and the object to be protected comparing the second biometric template with the biometric templates in a database in order to determine a possible second identifier;
16-V07: the object to be protected checking that the first identifier is identical to the second identifier;
17-V08: the object to be protected storing the second identifier, assigned a “validated” status, in the database; and
18-V09: the object to be protected destroying the encryption key and the object to be protected deactivating the reading of a graphic code by its sensor.

5. The method as claimed in claim 1, wherein the biometric check is performed on the face, an eye, a fingerprint, a palm or a voice and wherein a biometric capture is respectively an image of the face, an image of the eye, an image of the fingerprint, an image of the palm or a sound recording of the voice, and wherein the sensor performing a biometric capture is, as applicable, a photographic appliance, a camera or a microphone.

6. The method as claimed in claim 1, wherein the graphic code is a barcode, a QR code, or any other equivalent graphic means, and wherein the sensor is a dedicated reader or a camera.

7. The method as claimed in claim 1, wherein the object to be protected is a motor vehicle.

8. The method as claimed in claim 1, wherein the usage parameters include:
access authorization: unlocking an opening, all the openings, the trunk;
engine start authorization: yes/no, number of times;
delegation authorization: yes/no;
delegation time: start date, duration or end date, or permanent delegation.

9. A biometric recognition system for controlling access to an object to be protected, implementing a remote delegation method as claimed in claim 1.
